(19) United States
(12) Patent Application Publication
(10) Pub. No.: US 2026/0369079 A1
(43) Pub. Date: Nov. 19, 2026

(54) METHOD FOR PREDICTING TRAVERSABILITY PROBABILITY USING KNOWLEDGE DISTILLATION, AND SYSTEM THEREFOR

(71) Applicant: Gachon University of Industry-Academic cooperation Foundation, Seongnam-si (KR)

(72) Inventors: Jhonghyun An, Seoul (KR); NAHYEONG KIM, Gyeonggi-do (KR); Seongkyu Choi, Gyeonggi-do (KR); YOUNGJAE CHEONG, Gyeonggi-do (KR); Yejun Lee, Gyeonggi-do (KR)

(21) Appl. No.: 19/653,143

(22) Filed: Apr. 21, 2026

(30) Foreign Application Priority Data
May 19, 2025 (KR) 10-2025-0064521

(51) Int. Cl. G06V 20/56; G06V 10/764; G06V 10/82

(52) U.S. Cl. CPC G06V 20/588; G06V 10/764; G06V 10/82

(57) ABSTRACT

The technical spirit of the present invention relates to a method for predicting traversability probability using knowledge distillation, and to a system for performing the same. A traversability probability prediction method performed by at least one processor according to an embodiment of the present disclosure may include obtaining, using a teacher model, traversability probability for an image dataset including a plurality of road images, training a student model using a pair including the image dataset and the obtained traversability probability, and determining traversability probability for an input image using the student model.

### CROSS-REFERENCE TO RELATED APPLICATION

This application claims priority to and the benefit of Korean Patent Application No. 10-2025-0064521, filed on May 19, 2025, the disclosure of which is incorporated herein by reference in its entirety.

### BACKGROUND

### Technical Field

The present disclosure relates to a method for predicting traversability probability using knowledge distillation, and to a system therefor.

### Background Art

Autonomous driving technology has significantly improved safety and efficiency in road environments over the past several years. However, because off-road environments lack roads, have irregular terrain, and frequently involve obstacles and weather changes, considerable difficulties exist in applying such technology thereto. In particular, in the case of a special-purpose vehicle such as a military unmanned ground vehicle (UGV), a method of probabilistically evaluating traversability of an entire scene, rather than simply classifying a traversable region in a binary manner, enables more efficient decision-making. Accordingly, traversability determination technology for off-road environments has emerged as an important issue.

Most conventional studies related to off-road driving have focused on segmentation-based analysis using limited datasets or on approaches dependent on refined labeled data. However, such methods are difficult to suitably address off-road situations in which terrain diversity and environmental changes are substantial, and have a limitation in that securing training data requires significant time and cost. Recently, a knowledge distillation approach has attracted attention in which traversability information is generated using a model such as the GPT series, which is a large language model (LLM), and the generated information is transferred to a lightweight model.

### SUMMARY

### Technical Problem

An object of the present invention is to provide a traversability probability prediction system capable of real-time prediction by generating traversability probability values for various off-road images using a teacher model and training a student model based thereon.

### Technical Solution

A traversability probability prediction method performed by at least one processor according to an embodiment of the present disclosure may include obtaining, using a teacher model, traversability probability for an image dataset including a plurality of road images, training a student model using a pair including the image dataset and the obtained traversability probability, and providing, to a user device, traversability probability for an input image using the student model.

In one embodiment, the obtaining of the traversability probability for the image dataset may include obtaining at least one prompt for obtaining the traversability probability from the teacher model, obtaining a first traversability probability distribution by inputting, to the teacher model, a pair including a first prompt among the at least one prompt and a sample road image, obtaining a second traversability probability distribution by re-inputting, to the teacher model, the pair including the first prompt and the sample road image, and evaluating the first prompt using the first traversability probability distribution and the second traversability probability distribution.

In one embodiment, the evaluating of the first prompt may include obtaining an overlap coefficient of the first traversability probability distribution and the second traversability probability distribution, and calculating an evaluation score for the first prompt to be proportional to the overlap coefficient.

In one embodiment, the obtaining of the traversability probability for the image dataset may include obtaining at least three traversability probability distributions corresponding to the first prompt, obtaining overlap coefficients among the at least three traversability probability distributions, and calculating an evaluation score for the first prompt to be proportional to the overlap coefficients.

In one embodiment, the obtaining of the traversability probability for the image dataset may further include calculating an evaluation score for the first prompt, calculating an evaluation score for a second prompt among the at least one prompt, and obtaining traversability probability for the image dataset using a prompt having a higher evaluation score from among the first prompt and the second prompt.

In one embodiment, the training of the student model using the pair including the image dataset and the obtained traversability probability may include obtaining, as target data, a pair including the image dataset and traversability probability obtained from the teacher model in correspondence with the image dataset and training the student model using predefined multi-class classification based on the target data.

In one embodiment, the training of the student model using the predefined multi-class classification based on the target data may include obtaining traversability probability for the image dataset from the student model using the multi-class classification, comparing the obtained traversability probability with traversability probability of the target data, and modifying a feature map of the student model based on a result of the comparing.

In one embodiment, the multi-class classification may include a first layer indicating terrain conditions for an input image, a second layer indicating characteristic classification of the terrain conditions, a third layer indicating a state according to the characteristic classification, and classification scores according to the first layer to the third layer.

In one embodiment, the obtaining of the traversability probability for the image dataset from the student model using the multi-class classification may include classifying the plurality of road images included in the image dataset based on the first layer to the third layer using the student model, obtaining at least one classification score according to a result of the classifying, and obtaining the traversability probability using the at least one classification score.

A computing system according to an embodiment of the present disclosure may include a memory storing at least one instruction for performing a traversability probability prediction method and a processor configured to perform the traversability probability prediction method by executing the at least one instruction, wherein the processor may include a traversability probability acquisition module configured to obtain traversability probability for an image dataset including a plurality of road images from a teacher model and a model training module configured to train a student model using a pair including the image dataset and the obtained traversability probability.

In one embodiment, the traversability probability acquisition module may obtain at least one prompt for obtaining the traversability probability from the teacher model, obtain a first traversability probability distribution by inputting, to the teacher model, a pair including a first prompt among the at least one prompt and a sample road image, obtain a second traversability probability distribution by re-inputting, to the teacher model, the pair including the first prompt and the sample road image, and evaluate the first prompt using the first traversability probability distribution and the second traversability probability distribution.

In one embodiment, the traversability probability acquisition module may obtain an overlap coefficient of the first traversability probability distribution and the second traversability probability distribution and calculate an evaluation score for the first prompt to be proportional to the overlap coefficient.

In one embodiment, the traversability probability acquisition module may calculate an evaluation score for the first prompt, calculate an evaluation score for a second prompt among the at least one prompt, and obtain traversability probability for the image dataset using a prompt having a higher evaluation score from among the first prompt and the second prompt.

In one embodiment, the model training module may obtain, as target data, a pair including the image dataset and traversability probability obtained from the teacher model in correspondence with the image dataset and train the student model using predefined multi-class classification based on the target data.

In one embodiment, the model training module may obtain traversability probability for the image dataset from the student model using the multi-class classification and modify a feature map of the student model by comparing the obtained traversability probability with traversability probability of the target data.

In one embodiment, the multi-class classification may include a first layer indicating terrain conditions for an input image, a second layer indicating characteristic classification of the terrain conditions, a third layer indicating a state according to the characteristic classification, and classification scores according to the first layer to the third layer.

In one embodiment, the model training module may classify the plurality of road images included in the image dataset based on the first layer to the third layer using the student model and obtain traversability probability using at least one classification score obtained according to a result of the classifying.

### Effects of the Invention

According to the technical spirit of the present invention, by using a large language model such as GPT as a teacher model to generate traversability probability values for various off-road images and training a small student model based thereon, it is possible to provide a lightweight traversability probability prediction system capable of real-time prediction.

### BRIEF DESCRIPTION OF THE DRAWINGS

FIG. 1 is a block diagram illustrating a system according to an exemplary embodiment of the present disclosure.

FIG. 2 is a flowchart illustrating a traversability probability prediction method according to an exemplary embodiment of the present disclosure.

FIG. 3 is a flowchart illustrating a traversability probability prediction method according to an exemplary embodiment of the present disclosure.

FIG. 4 is a flowchart illustrating a traversability probability prediction method according to an exemplary embodiment of the present disclosure.

FIG. 5 is a diagram illustrating a traversability probability distribution according to an exemplary embodiment of the present disclosure.

FIG. 6 is a table illustrating a prompt evaluation result according to an exemplary embodiment of the present disclosure.

FIG. 7 is a flowchart illustrating a traversability probability prediction method according to an exemplary embodiment of the present disclosure.

FIG. 8 is a flowchart illustrating a traversability probability prediction method according to an exemplary embodiment of the present disclosure.

FIG. 9 is a table illustrating multi-class classification according to an exemplary embodiment of the present disclosure.

FIG. 10 is a block diagram illustrating a computing system according to an exemplary embodiment of the present disclosure.

### DETAILED DESCRIPTION

Hereinafter, preferred embodiments of the present invention will be described in detail with reference to the accompanying drawings. The advantages and features of the present invention, and methods for achieving the same, will become apparent with reference to the embodiments described in detail below in conjunction with the accompanying drawings. However, the technical spirit of the present invention is not limited to the embodiments set forth below and may be implemented in various different forms. Rather, the embodiments set forth below are provided only to make the technical spirit of the present invention complete and to fully inform those skilled in the art to which the present invention pertains of the scope of the present invention, and the technical spirit of the present invention is defined only by the scope of the claims.

In assigning reference numerals to elements of the drawings, it should be noted that like elements are denoted by like reference numerals wherever possible even though they are illustrated in different drawings. In addition, in describing the present invention, when it is determined that a detailed description of a related known configuration or function may obscure the gist of the present invention, the detailed description thereof will be omitted.

Unless otherwise defined, all terms used herein, including technical and scientific terms, may be used with meanings commonly understood by those of ordinary skill in the art to which the present invention pertains. In addition, terms defined in generally used dictionaries should not be interpreted ideally or excessively unless clearly and specifically defined otherwise. The terms used in this specification are for describing the embodiments and are not intended to limit the present invention. As used herein, the singular forms include the plural forms as well, unless the context clearly indicates otherwise.

In describing elements of the present invention, terms such as first, second, A, B, (a), and (b) may be used. These terms are used only to distinguish one element from another element, and the nature, order, or sequence of the corresponding element is not limited by such terms. When an element is described as being "connected," "coupled," or "linked" to another element, it should be understood that the element may be directly connected or linked to the other element, but that another element may also be "connected," "coupled," or "linked" between the elements.

As used in the present invention, "comprises" and/or "comprising" do not preclude the presence or addition of one or more other elements, steps, operations, and/or components in addition to the stated elements, steps, operations, and/or components.

An element included in one embodiment and an element including a common function may be described in another embodiment using the same name. Unless stated otherwise, the description set forth in one embodiment may also be applied to another embodiment, and detailed descriptions may be omitted within overlapping ranges or within ranges that can be readily understood by a person having ordinary skill in the art.

Hereinafter, the present invention will be described in detail with reference to preferred embodiments of the present invention and the accompanying drawings.

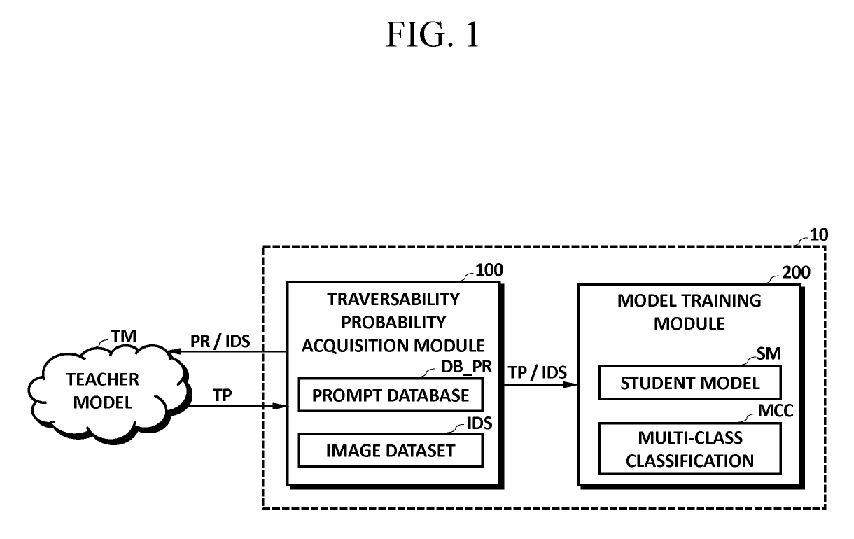

FIG. 1 is a block diagram illustrating a system according to an exemplary embodiment of the present disclosure.

Referring to FIG. 1, the system 10 may refer to a device or network for training a student model SM using traversability probability TP obtained from a teacher model TM by using a knowledge distillation technique in order to determine traversability probability TP for an input image. To this end, the system 10 may be implemented as at least one server or terminal device. When the system 10 is a server, the system 10 may be implemented in a cloud environment, and when the system 10 is a terminal device, the system 10 may include various communicable terminal devices such as a cellular phone, a smart phone, a laptop, a personal computer (PC), a navigation device, a personal communication system (PCS), a global system for mobile communications (GSM), a personal digital cellular (PDC), a personal handyphone system (PHS), a personal digital assistant (PDA), an international mobile telecommunication (IMT)-2000 device, a code division multiple access (CDMA)-2000 device, a W-code division multiple access (W-CDMA) device, a wireless broadband Internet (Wibro) terminal, a smart pad, and a tablet PC.

Each component of the system 10 and the teacher model TM may be connected so as to communicate with each other through wired or wireless communication. When connected in a wired manner, each component included in the system 10 and the teacher model TM may communicate using a serial scheme. When connected in a wireless manner, each component included in the system 10 and the teacher model TM may communicate with each other using a wireless communication network, and the wireless communication network may include, but is not limited to, a local area network (LAN), a wide area network (WAN), the World Wide Web (WWW), a wired/wireless data communication network, a telephone network, a wired/wireless television communication network, 3G, 4G, 5G, the 3rd Generation Partnership Project (3GPP), the 5th Generation Partnership Project (5GPP), long term evolution (LTE), worldwide interoperability for microwave access (WiMAX), Wi-Fi, the Internet, a local area network (LAN), a wireless local area network (Wireless LAN), a wide area network (WAN), a personal area network (PAN), radio frequency (RF), a Bluetooth network, a near-field communication (NFC) network, a satellite broadcasting network, an analog broadcasting network, and a digital multimedia broadcasting (DMB) network.

The teacher model TM may refer to a large language model capable of understanding and generating language in a human-like manner by learning large-scale text data, and may include, for example, GPT (Generative Pre-trained Transformer), BERT (Bidirectional Encoder Representations from Transformers), LLaMA (Large Language Model Meta AI), and Claude.

The system 10 may include a traversability probability acquisition module 100 and a model training module 200. The traversability probability acquisition module 100 and the model training module 200 may be configured as mutually distinct software modules, and may be driven by a single processor or by separate processors.

The traversability probability acquisition module 100 may obtain traversability probability TP for an image dataset IDS from the teacher model TM by inputting a prompt PR stored in a prompt database DB_PR to the teacher model TM. In this specification, the prompt PR refers to an input sentence for instructing the teacher model TM to perform a specific task or asking a question, and more specifically, may refer to an input sentence finely tuned to obtain, from the teacher model TM, traversability probability TP for the image dataset IDS.

In addition, in this specification, traversability probability TP may refer to a possibility or degree indicating whether a vehicle can safely and smoothly travel on a particular terrain or path in an actual environment present in an image, and may have a value between 0% and 100%. In addition, in this specification, the image dataset IDS may refer to a plurality of road images captured or generated in advance with respect to an environment in which a vehicle may operate, and in one example, may include RUGD (Robot Unstructured Ground Dataset).

In one embodiment, the traversability probability acquisition module 100 may evaluate a plurality of prompts PR stored in the prompt database DB_PR and may obtain traversability probability TP from the teacher model TM using an optimal prompt PR selected based on an evaluation result.

The model training module 200 may train the student model SM using the traversability probability TP obtained by the traversability probability acquisition module 100 and the image dataset IDS. In one embodiment, the model training module 200 may train the student model SM by using the traversability probability TP generated by the teacher model TM as target data. In one example, the student model SM may be configured as any one of ResNet-18, ResNet-50, ResNet-101, ViT-S/16, and ViT-B/16, and may use, as training data, pairs of images included in the image dataset IDS and traversability probability TP.

In one embodiment, the model training module 200 may train the student model SM using multi-class classification (MCC). In this specification, the multi-class classification MCC may refer to classifying classes according to a specific driving condition and assigning differentiated scores to respective classes, and the model training module 200 may train the student model SM such that traversability probability determined based on the multi-class classification MCC matches traversability probability as target data, and a loss function, for example, cross-entropy loss, may be used as a training scheme.

In another embodiment, the model training module 200 may train the student model SM through a regression scheme. The regression scheme is a scheme for predicting a continuous numerical value rather than a discrete label, and mean square error may be selected as a loss function for the training scheme.

The trained student model SM may be mounted on an edge device, for example, Jetson Orin, and may be used to predict traversability probability for an input image.

According to the technical spirit of the present disclosure, by using a knowledge distillation scheme in which traversability probability TP obtained from the teacher model TM is used as target data, which is determine as ground-truth data by user, to train the student model SM, the student model SM occupying fewer resources can be efficiently trained to a level similar to that of the teacher model TM occupying higher resources, and as a result, efficient traversability probability prediction using fewer resources may be enabled.

In this specification, operations of the system 10 and components included therein may refer to operations performed by a processor included in each component based on a computer program including at least one instruction stored in a storage device included in each component, and the storage device may include non-volatile memory, volatile memory, flash memory, a hard disk drive (HDD), or a solid state drive (SSD). In addition, the processor may include at least one of a central processing unit (CPU), a graphic processing unit (GPU), a neural processing unit (NPU), random access memory (RAM), read-only memory (ROM), a system bus, and an application processor.

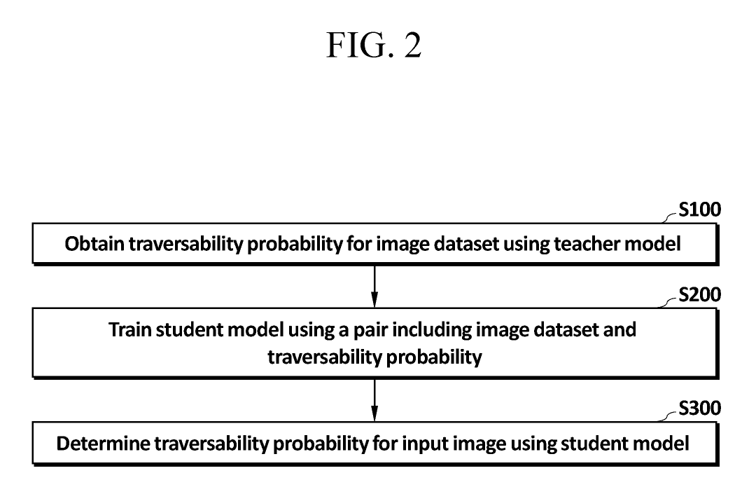

FIG. 2 is a flowchart illustrating a traversability probability prediction method according to an exemplary embodiment of the present disclosure.

Referring to FIG. 2, the system 10 may obtain traversability probability TP for the image dataset IDS using the teacher model TM (S100).

The system 10 may train the student model SM using a pair including the image dataset IDS and the traversability probability TP (S200).

The system 10 may determine traversability probability TP for an input image using the trained student model SM (S300).

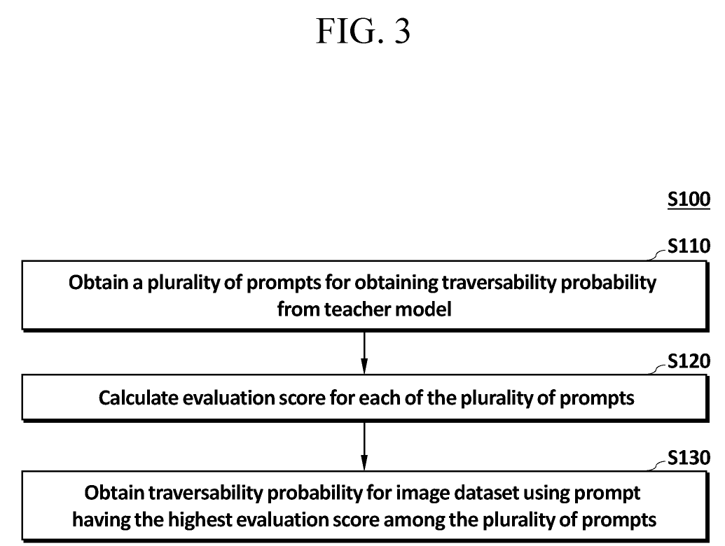

FIG. 3 is a flowchart illustrating a traversability probability prediction method according to an exemplary embodiment of the present disclosure. More specifically, FIG. 3 illustrates step S100 of obtaining traversability probability TP for the image dataset IDS of FIG. 2.

Referring to FIG. 3, the system 10 may obtain a plurality of prompts for obtaining traversability probability TP from the teacher model TM (S110). In one embodiment, the system 10 may obtain, from the prompt database DB_PR, a plurality of predetermined prompts for obtaining traversability probability TP for a road image from the teacher model TM.

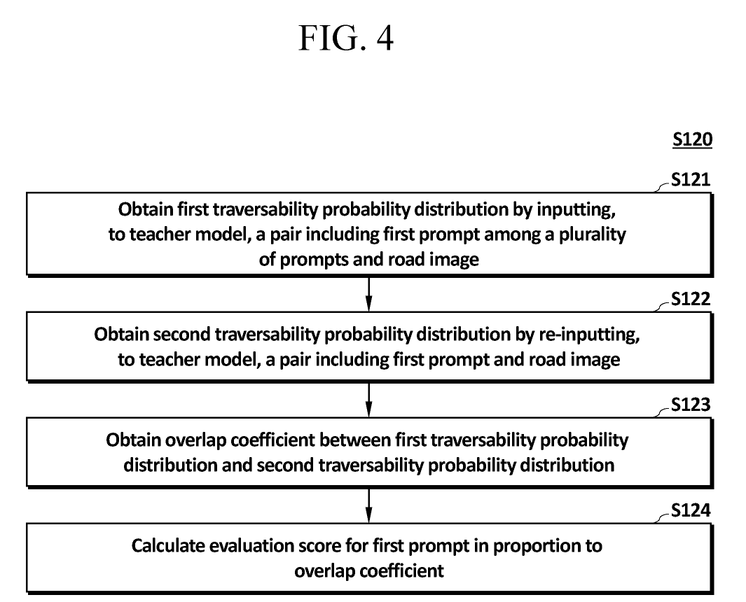

The system 10 may calculate an evaluation score for each of the plurality of prompts (S120). The system 10 may select, using the evaluation scores, a prompt capable of stably evaluating traversability probability TP. In one embodiment, the system 10 may assign the evaluation score using an overlap coefficient (OVL), which will be described in detail below with reference to FIGS. 4-6. In another embodiment, the system 10 may assign the evaluation score using a Kolmogorov-Smirnov (KS) statistic. In this case, the system 10 may measure a maximum difference between cumulative distribution functions corresponding to the prompt, and may assign a higher evaluation score as the value of the maximum difference becomes smaller.

The system 10 may obtain traversability probability TP for each of the plurality of road images included in the image dataset IDS by inputting, to the teacher model TM, the prompt PR having the highest evaluation score among the plurality of prompts together with the image dataset IDS (S130).

According to an embodiment of the present disclosure, a prompt PR for obtaining, from the teacher model TM, traversability probability TP having high accuracy may be evaluated based on a stability-based evaluation method, and traversability probability TP may be obtained from the teacher model TM using the prompt PR having a high evaluation score. As a result, traversability probability TP having high accuracy may be obtained, and reliability of the traversability probability TP as target data may be improved.

FIG. 4 is a flowchart illustrating a traversability probability prediction method according to an exemplary embodiment of the present disclosure. More specifically, FIG. 4 illustrates step S120 of calculating evaluation scores for the plurality of prompts of FIG. 3.

Referring to FIG. 4, the system 10 may obtain a first traversability probability distribution by inputting, to the teacher model TM, a pair including the first prompt among the plurality of prompts and a road image included in the image dataset IDS (S121). In addition, the system 10 may obtain a second traversability probability distribution by re-inputting, to the teacher model TM, the pair including the same first prompt and the same road image (S122). In this specification, the traversability probability distribution refers to data or a graph representing a distribution of a probability that a vehicle is able to travel with respect to a specific image.

The system 10 may evaluate stability of the corresponding prompt by calculating an overlap coefficient between the first traversability probability distribution and the second traversability probability distribution (S123). In this specification, the overlap coefficient is a similarity index quantitatively indicating how much two probability distributions overlap each other, and the more similar the two probability distributions are, the higher the overlap coefficient may be evaluated, and the more different the two probability distributions are, the lower the overlap coefficient may be evaluated. The system 10 may calculate an evaluation score for the first prompt in proportion to the calculated overlap coefficient (S124).

According to an embodiment of the present disclosure, quality of a prompt may be quantitatively evaluated based on how consistently the teacher model outputs a result for the same input, and accordingly, a prompt most suitable for evaluating traversability probability may be selected. As a result, the system 10 may generate a high-precision traversability probability prediction result.

Although FIG. 4 illustrates an example in which an overlap coefficient between two traversability probability distributions is used, this is merely an example, and it should be understood that the technical spirit of the present disclosure may also be applied to an example in which an evaluation score is calculated using an overlap coefficient among more than two traversability probability distributions.

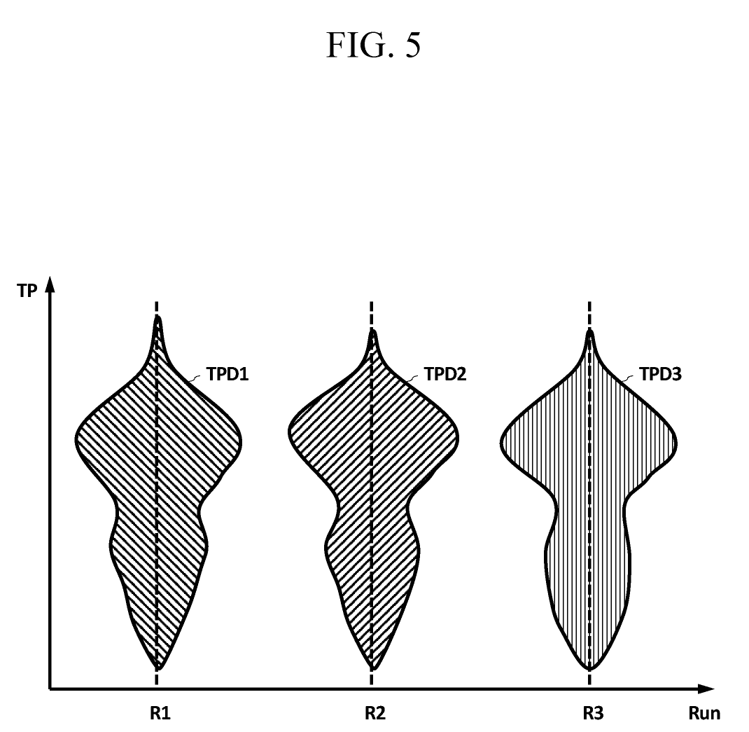

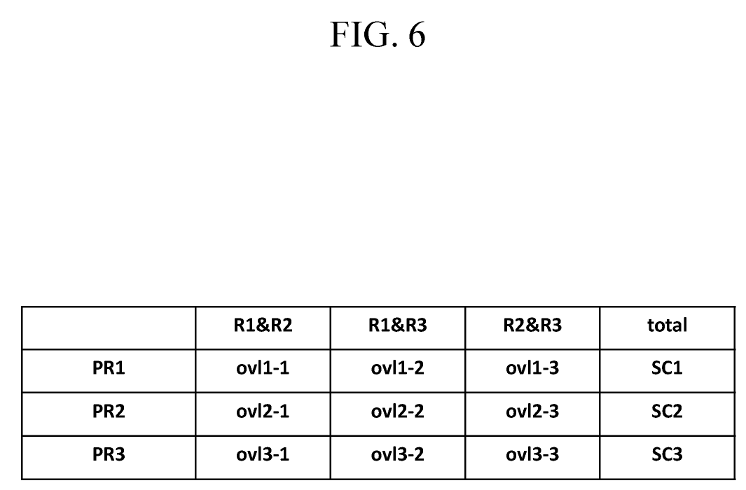

FIG. 5 is a diagram illustrating a traversability probability distribution according to an exemplary embodiment of the present disclosure, and FIG. 6 is a table illustrating a prompt evaluation result according to an exemplary embodiment of the present disclosure.

Referring to FIG. 5, the system 10 may obtain three traversability probability distributions TPD1 to TPD3 by repeatedly providing the same first prompt PR1 and the same road image to the teacher model TM. More specifically, in a first round R1, the system 10 may obtain a first traversability probability distribution TPD1 by inputting the first prompt and the road image to the teacher model TM, in a second round R2, the system 10 may obtain a second traversability probability distribution TPD2 by inputting the first prompt and the road image to the teacher model TM, and in a third round R3, the system 10 may obtain a third traversability probability distribution TPD3 by inputting the first prompt and the road image to the teacher model TM.

Referring to FIG. 6, for the first prompt PR1, the system 10 may obtain a first overlap region ovl1-1 between the first traversability probability distribution PRD1 and the second traversability probability distribution PRD2, obtain a second overlap region ovl1-2 between the first traversability probability distribution PRD1 and the third traversability probability distribution PRD3, and obtain a third overlap region ovl1-3 between the second traversability probability distribution PRD2 and the third traversability probability distribution PRD3. In addition, the system 10 may calculate a first evaluation score SC1 based on the first overlap region ovl1-1 to the third overlap region ovl1-3. In one example, the first evaluation score SC1 may be determined to be proportional to the first overlap region ovl1-1 to the third overlap region ovl1-3.

In a similar manner, the system 10 may obtain a second evaluation score SC2 corresponding to the second prompt PR2 and a third evaluation score SC3 corresponding to the third prompt PR3. In one embodiment, the system 10 may use the same road image when evaluating the first prompt PR1 to the third prompt PR3.

The system 10 may determine a prompt having the highest score based on the first evaluation score SC1 to the third evaluation score SC3. In addition, the system 10 may obtain, using the determined prompt, a pair including the image dataset and traversability probability corresponding to target data.

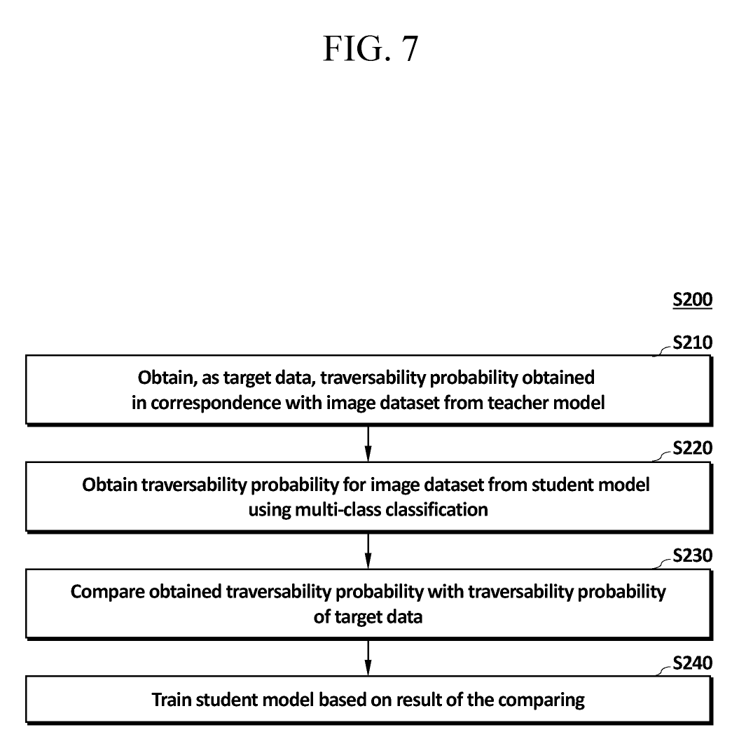

FIG. 7 is a flowchart illustrating a traversability probability prediction method according to an exemplary embodiment of the present disclosure. More specifically, FIG. 7 illustrates step S200 of training the student model SM of FIG. 2.

Referring to FIG. 7, the system 10 may obtain, as target data, traversability probability TP obtained in correspondence with the image dataset IDS from the teacher model TM (S210). The traversability probability TP may correspond to a probability determined by the teacher model TM for each road image and may serve as a ground-truth label used for training the student model SM.

The system 10 may calculate, using the student model SM, traversability probability TP for each road image included in the image dataset IDS based on a multi-class classification (MCC) scheme (S220). In this specification, multi-class classification (MCC) is a supervised learning scheme in which one item of input data is classified as belonging to one of a plurality of mutually exclusive classes. In one embodiment, the system 10 may determine traversability probability TP of a road image using multi-class classification (MCC) according to hierarchical classification criteria reflecting terrain conditions, characteristics of obstacles, environmental factors, and the like.

The system 10 may compare traversability probability predicted by the student model SM with traversability probability TP of target data obtained from the teacher model TM (S230). In addition, the system 10 may analyze a difference between the two obtained traversability probabilities and progressively improve performance of the model by training a feature map of the student model SM based thereon (S240).

According to the present embodiment, the system 10 may efficiently train the student model SM such that traversability probability TP may be predicted with high accuracy even through the lightweight student model SM by efficiently transfer-learning prediction capability of the teacher model TM.

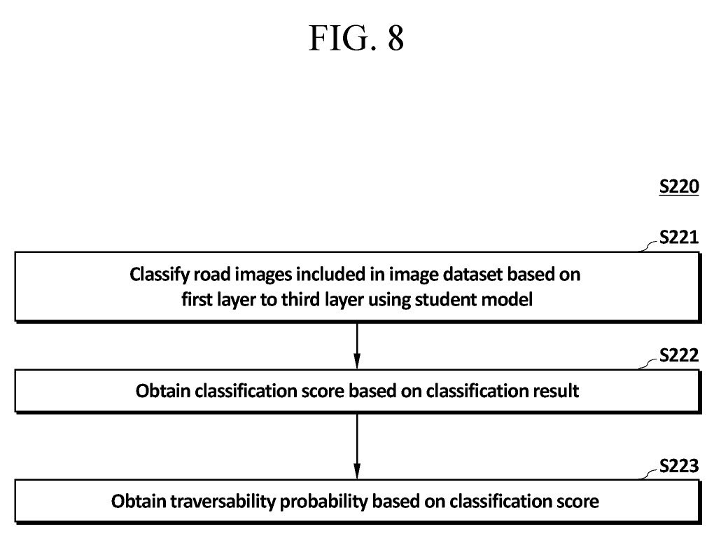

FIG. 8 is a flowchart illustrating a traversability probability prediction method according to an exemplary embodiment of the present disclosure. More specifically, FIG. 8 illustrates step S220 of obtaining traversability probability for the image dataset IDS using multi-class classification (MCC) of FIG. 7.

The system 10 may first classify each road image included in the image dataset IDS, using the student model, according to multi-class classification (MCC) criteria including a first layer to a third layer (S221). In one embodiment, the multi-class classification (MCC) may include a first layer indicating terrain conditions for a road image, a second layer indicating characteristic classification of the terrain conditions, a third layer indicating a state according to the characteristic classification, and classification scores according to the first layer to the third layer.

The system 10 may obtain classification scores based on classification results for each layer (S222). The classification scores indicate scores corresponding to cases in which the system 10 determines, using the student model SM, that the road image belongs to a specific class of each layer, and may be used as an indicator directly related to traversability probability.

The system 10 may obtain final traversability probability TP based on a value obtained by summing the obtained classification scores or combining the obtained classification scores using a weighted average scheme or the like (S223).

According to an embodiment of the present disclosure, by determining traversability probability TP based on multi-class classification (MCC), precise determination of traversability probability TP in consideration of various environmental factors is enabled, and a highly reliable prediction result may be derived by objectively determining multi-layer terrain information.

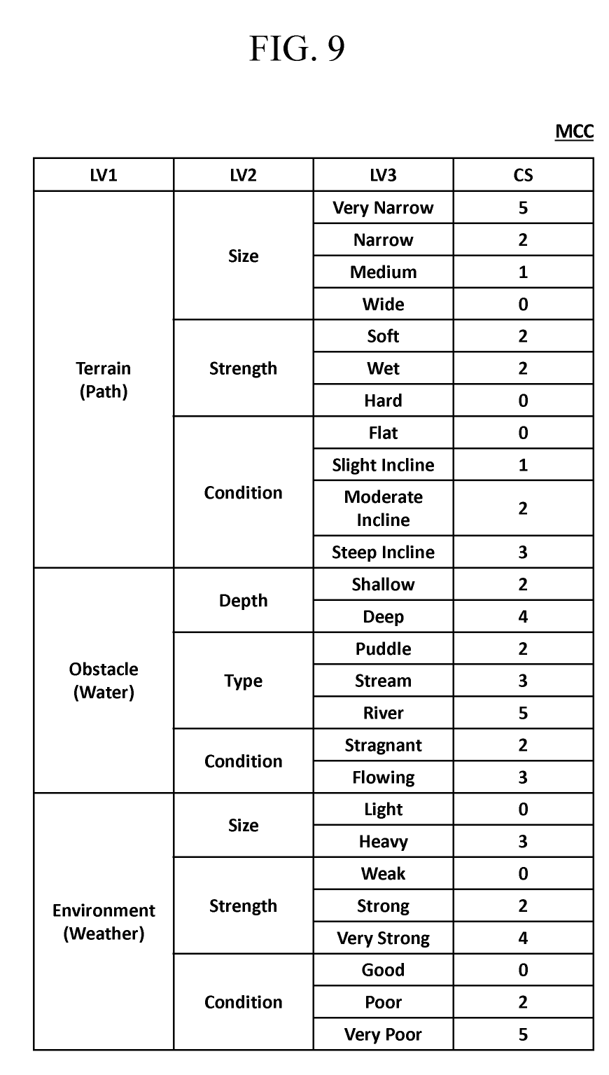

FIG. 9 is a table illustrating multi-class classification according to an exemplary embodiment of the present disclosure.

Referring to FIG. 9, the multi-class classification (MCC) may include a first layer LV1 indicating terrain conditions, a second layer LV2 indicating characteristic classification of the terrain conditions, a third layer LV3 indicating a state according to the characteristic classification, and classification scores CS according to the first layer LV1 to the third layer LV3.

The first layer LV1 may indicate terrain conditions for an input image. In one example, the first layer LV1 may include a path as terrain, water as an obstacle, and weather as an environment. The second layer LV2 may indicate characteristic classification of the first layer LV1. In one example, the second layer LV2 may include size/strength/condition of the path, depth/type/condition of the water, and size/strength/condition of the weather. In addition, the third layer LV3 may indicate a state of the second layer LV2, and various values may be assigned according to a degree thereof. In addition, classification scores CS may be assigned for each of the third layer LV3.

According to one embodiment, the student model SM may perform classification for each layer with respect to a road image. When the road image is an image depicting a narrow, wet, and steep road, the student model SM may select “Path” as the first layer LV1 for the image, and may obtain “Size-Narrow (CS=2),” “Strength-Wet (CS=2),” and “Condition-Steep Incline (CS=3)” for the second layer LV2 and the third layer LV3. Accordingly, traversability probability may be calculated based on a result of summing the obtained classification scores.

According to an embodiment of the present disclosure, when determining traversability probability from the student model SM, the system 10 may perform classification in an explainable form as to why driving is possible by using the multi-class classification (MCC) having a hierarchical structure of terrain condition → terrain characteristic → state, and interpretability of traversability probability determination may be improved. In addition, the system 10 may categorize traversability probability as target data obtained from the teacher model TM so as to help the student model SM learn stably, and relatively fast inference may be enabled.

It should be understood that the multi-class classification (MCC) table of FIG. 9 is merely an example, and that the classification scheme for each layer of the multi-class classification (MCC) according to the technical spirit of the present disclosure is not limited to the example of FIG. 9 and may be variously determined.

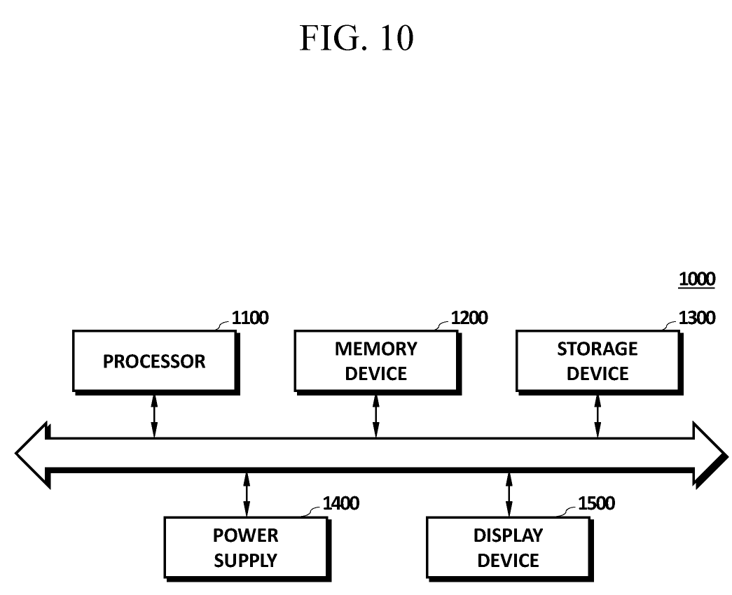

FIG. 10 is a block diagram illustrating a computing system according to an exemplary embodiment of the present disclosure.

Referring to FIG. 10, the computing system 1000 may constitute the system 10 and may include a processor 1100, a memory device 1200, a storage device 1300, a power supply 1400, and a display device 1500. Meanwhile, although not illustrated in FIG. 10, the computing system 1000 may further include ports capable of communicating with a video card, a sound card, a memory card, a USB device, or other electronic devices.

As described above, the processor 1100, the memory device 1200, the storage device 1300, the power supply 1400, and the display device 1500 included in the computing system 1000 may constitute any one of the systems 10 according to embodiments based on the technical spirit of the present invention and may perform the traversability probability prediction method. Specifically, the processor 1100 may perform the traversability probability prediction method of the system 10 described above with reference to FIGS. 1-9 by controlling the memory device 1200, the storage device 1300, the power supply 1400, and the display device 1500.

The processor 1100 may perform specific computations or tasks. Depending on the embodiment, the processor 1100 may be a microprocessor or a central processing unit (CPU). The processor 1100 may communicate with the memory device 1200, the storage device 1300, and the display device 1500 through a bus such as an address bus, a control bus, and a data bus. Depending on the embodiment, the processor 1100 may also be connected to an expansion bus such as a Peripheral Component Interconnect (PCI) bus.

The memory device 1200 may store data required for operation of the computing system 1000. For example, the memory device 1200 may be implemented as dynamic random access memory (DRAM), mobile DRAM, static random access memory (SRAM), phase-change random access memory (PRAM), ferroelectric random access memory (FRAM), resistive random access memory (RRAM), and/or magnetic random access memory (MRAM). The storage device 1300 may include a solid state drive, a hard disk drive, a CD-ROM, or the like. The storage device 1300 may store a program related to the traversability probability prediction method described above with reference to FIGS. 1-9, application program data, system data, operating system data, and the like.

The display device 1500 is an output means for providing a notification to a user and may display and provide, to the user or the like, information regarding the traversability probability prediction method. The power supply 1400 may supply an operating voltage required for operation of the computing system 1000.

As described above, exemplary embodiments have been disclosed in the drawings and the specification. Although specific terms have been used in this specification to describe the embodiments, such terms are used only for the purpose of describing the technical spirit of the present invention and are not used to limit the meaning thereof or to limit the scope of the present invention set forth in the claims. Therefore, those of ordinary skill in the art will understand that various modifications and equivalent other embodiments may be made therefrom. Accordingly, the true technical protection scope of the present invention should be defined by the technical spirit of the appended claims.

What is claimed is:

1. A traversability probability prediction method performed by at least one processor, the method comprising:
obtaining, using a teacher model, traversability probability for an image dataset including a plurality of road images;
training a student model using a pair including the image dataset and the obtained traversability probability; and
providing, to a user device, traversability probability for an input image using the student model.

2. The method of claim 1, wherein the obtaining of the traversability probability for the image dataset comprises:
obtaining at least one prompt for obtaining the traversability probability from the teacher model;
obtaining a first traversability probability distribution by inputting, to the teacher model, a pair including a first prompt among the at least one prompt and a sample road image;
obtaining a second traversability probability distribution by re-inputting, to the teacher model, the pair including the first prompt and the sample road image; and
evaluating the first prompt using the first traversability probability distribution and the second traversability probability distribution.

3. The method of claim 2, wherein the evaluating of the first prompt comprises:
obtaining an overlap coefficient of the first traversability probability distribution and the second traversability probability distribution; and
calculating an evaluation score for the first prompt to be proportional to the overlap coefficient.

4. The method of claim 2, wherein the obtaining of the traversability probability for the image dataset comprises:
obtaining at least three traversability probability distributions corresponding to the first prompt;
obtaining overlap coefficients among the at least three traversability probability distributions; and
calculating an evaluation score for the first prompt to be proportional to the overlap coefficients.

5. The method of claim 2, wherein the obtaining of the traversability probability for the image dataset comprises:
calculating an evaluation score for the first prompt;
calculating an evaluation score for a second prompt among the at least one prompt; and
obtaining traversability probability for the image dataset using a prompt having a higher evaluation score from among the first prompt and the second prompt.

6. The method of claim 1, wherein the training of the student model using the pair including the image dataset and the obtained traversability probability comprises:
obtaining, as target data, a pair including the image dataset and traversability probability obtained from the teacher model in correspondence with the image dataset; and
training the student model using predefined multi-class classification based on the target data.

7. The method of claim 6, wherein the training of the student model using the predefined multi-class classification based on the target data comprises:
obtaining traversability probability for the image dataset from the student model using the multi-class classification;
comparing the obtained traversability probability with traversability probability of the target data; and
training a feature map of the student model based on a result of the comparing.

8. The method of claim 7, wherein the multi-class classification comprises:
a first layer indicating terrain conditions for an input image;
a second layer indicating characteristic classification of the terrain conditions;
a third layer indicating a state according to the characteristic classification; and
classification scores according to the first layer to the third layer.

9. The method of claim 7, wherein the obtaining of the traversability probability for the image dataset from the student model using the multi-class classification comprises:
classifying the plurality of road images included in the image dataset based on the first layer to the third layer using the student model;
obtaining at least one classification score according to a result of the classifying; and
obtaining traversability probability using the at least one classification score.

10. A computing system comprising:
a memory storing at least one instruction for performing a traversability probability prediction method; and
a processor configured to perform the traversability probability prediction method by executing the at least one instruction,
wherein the processor comprises:
a traversability probability acquisition module configured to obtain traversability probability for an image dataset including a plurality of road images from a teacher model; and
a model training module configured to train a student model using a pair including the image dataset and the obtained traversability probability.

11. The computing system of claim 10, wherein the traversability probability acquisition module is configured to:
obtain at least one prompt for obtaining the traversability probability from the teacher model;
obtain a first traversability probability distribution by inputting, to the teacher model, a pair including a first prompt among the at least one prompt and a sample road image;
obtain a second traversability probability distribution by re-inputting, to the teacher model, the pair including the first prompt and the sample road image; and
evaluate the first prompt using the first traversability probability distribution and the second traversability probability distribution.

12. The computing system of claim 11, wherein the traversability probability acquisition module is configured to:
obtain an overlap coefficient of the first traversability probability distribution and the second traversability probability distribution; and
calculate an evaluation score for the first prompt to be proportional to the overlap coefficient.

13. The computing system of claim 11, wherein the traversability probability acquisition module is configured to:
calculate an evaluation score for the first prompt;
calculate an evaluation score for a second prompt among the at least one prompt; and
obtain traversability probability for the image dataset using a prompt having a higher evaluation score from among the first prompt and the second prompt.

14. The computing system of claim 10, wherein the model training module is configured to:
obtain, as target data, a pair including the image dataset and traversability probability obtained from the teacher model in correspondence with the image dataset; and
train the student model using predefined multi-class classification based on the target data.

15. The computing system of claim 14, wherein the model training module is configured to:
obtain traversability probability for the image dataset from the student model using the multi-class classification; and
modify a feature map of the student model by comparing the obtained traversability probability with traversability probability of the target data.

16. The computing system of claim 15, wherein the multi-class classification comprises:
a first layer indicating terrain conditions for an input image;
a second layer indicating characteristic classification of the terrain conditions;
a third layer indicating a state according to the characteristic classification; and
classification scores according to the first layer to the third layer.

17. The computing system of claim 16, wherein the model training module is configured to:
classify the plurality of road images included in the image dataset based on the first layer to the third layer using the student model; and
obtain traversability probability using at least one classification score obtained according to a result of the classifying.
